(19) United States
(12) Patent Application Publication
(10) Pub. No.: US 2019/0069518 A1
(43) Pub. Date: Mar. 7, 2019

(54) INTERACTIVE PET TOY AND SYSTEM

(71) Applicant: Erica FALBAUM, Elm Grove, LA (US)

(72) Inventor: Erica FALBAUM, Elm Grove, LA (US)

(21) Appl. No.: 16/124,810

(22) Filed: Sep. 7, 2018

Related U.S. Application Data
(60) Provisional application No. 62/555,314, filed on Sep. 7, 2017.

(51) Int. Cl. A01K 15/02

(52) U.S. Cl. CPC A01K 15/025; A01K 15/021

(57) ABSTRACT

An interactive pet toy comprising a shell, a processor, a memory, a wireless transmitter, one or more sensors, an output, and a power source. The disclosed invention further relates to an interactive pet toy system comprising an interactive pet toy including a shell, a processor, a non-volatile memory, a wireless transmitter, one or more sensors, an output; and a battery; and a mobile device, comprising a processor, a display screen, a non-volatile memory, and a wireless transmitter, wherein instructions are stored on the interactive pet toy memory and the and the mobile device memories that, when enacted by the respective processors, each track an interaction between a user and a pet.

### CROSS REFERENCE TO RELATED APPLICATIONS/PRIORITY

The present invention claims priority to U.S. Provisional Patent Application No. 62/555,314 filed Sep. 7, 2017, which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND OF THE INVENTION

There is a need to interactively motivate and train young pet owners to interact and care for their pets on a regular basis.

### SUMMARY OF THE INVENTION

Wherefore, it is an object of the present invention to overcome the above mentioned shortcomings and drawbacks associated with the current technology. The present invention is directed to methods and apparatuses that satisfy the above shortcomings and drawbacks. The method and apparatus comprise interactive pet toys, sometimes referred to as “steppet smart pet toys” or “smart pet toys” and comprise systems and methods of using the interactive pet toys, including apps that run on the user's mobile device/computer, including apps that communicate with a PEP server use information from the user's interactive pet toy to compute pet interaction raking and rank the user as compared to other users, including users in the same area, with the same type of animal, of the same age, in the same country, or with other or with no similar demographics.

Multiple interactive pet toys for a single user may sync to one another and the PEP app to together track user/pet interaction for a given time period, such as a day. Either one, some, or all synced toys and or PEP app may blink or otherwise indicate that the daily goal has been met. In a preferred embodiment, only the interactive pet toy or toys currently being played and the PEP app with will blink or otherwise indicate that the goal has been met.

The interactive pet toy preferably has a wireless sensor, a wireless ultra-low power system, and syncs with a mobile device PEP app.

A preferably encased interior may consists of a battery sufficient power to power a preferably ultra-low power system, a sensor that collects data, a processor that measures and computes data, and a wireless transmitter to share data and sync the data to the PEP app on the user's mobile device.

The interactive pet toy may be in the form of a rubber ball that surrounds, cushions, and envelopes the encased layer of internal components.

The interactive pet toy ball may be spherical, or round/spherical with grooves that surround the interactive pet toy ball in a swirled design, for example. The interactive pet toy ball preferably has an embossed or printed logo. The interactive pet toy ball may also be a solid round design with no decorations. The interactive pet toy ball is preferably made of solid materials on the inside and the internal components encased in a pet safe shell.

The interactive pet toy wand is preferably an elongate device, including a handle, a rod, and an attachment. The internal electrical components, such as the processor, memory, and transmitter, for example, are preferably located within the handle. The handle and rod together preferably measure 18 inches to 36 inches in length. The attachment measures preferably 1 inch to 30 inches in length. The in one embodiment, the handle includes a swirled cushion cover that wraps around the bottom of the interactive pet toy wand. The bottom of the interactive pet toy wand may have a curved convex tip that continues the swirled design. There may be an embossed, printed, or raised logo printed on the handle. The rod is preferable comprised of a sturdy cylindrical rod that physically and preferably electrically connects the handle to the attachment. The end of the rod, opposite of the handle, preferably includes an attachment, such as an interchangeable clip on or screw on component to switch out different attachments to cater to cat's playing preferences. The attachment may have speakers, light/laser emitters, and/or sensors, for example, to enhance the functionality of the interactive pet toy wand, though such internal components would preferably be designed robustly enough to withstand play from a cat and still remain functional.

The interactive pet toy ball may be made of durable materials, including durable non-toxic rubber. The material may be opaque, transparent, or translucent. The interactive pet toy ball may include of a non-toxic natural or synthetic elastic material that has bounce when thrown against the ground. The inside electronic components may be encased in a pet safe shell that is able to pass through a pet's system in the case of accidental ingestion.

There may be materials or skins that wrap around the interactive pet toy ball to cater to a specific dog's or pets playing preferences. The skins may be permanent with the interactive pet toy, or interchangeable. The skins may be comprised tennis ball material, silicone, rubber, synthetic materials such as polyester, neoprene or spandex, and of different textures including smooth, fabric, ribbed, and bumped, for example. The inventor has discovered to her surprise that different dogs have divergently different chewing/chew toy texture preferences, and matching the dog with the specific favored material and texture will lead to the dog enjoying play more, and thus motivating the dog and owner to play more often.

The interactive pet toy wand handle may include a rubber, silicone, and/or foam material to allow for comfortable gripping. The rod may include a sturdy plastic, carbon, composite, metal, or other material that provides a slight bend to prevent the rod from breaking or snapping. The attachment may be made of plastic and/or metal for example, with, for example, a hidden screw that screws the attachment onto a threaded recess at the end of the rod, or attachment clip. The attachments can also or alternatively include other materials, such as strings, feathers, and synthetic materials.

There are various manners of inputting information, directions, and power into the interactive pet toy. These may include, for example, a button or buttons to turn on and off the interactive pet toy, and to potentially enter data and directions about the user, pet, and desired play activities. The interactive pet toy may include a charging input, either a socket or inductive, for example. The interactive pet toy may include wireless, Bluetooth, and/or cellular transmitter/receiver to input and transmit data. Sensors in the interactive pet toy may detect sound, light, motion, temp, humidity, and GPS, for example. These and other sensors, when used alone or with the PEP app on the users mobile device, can help determine and alter the user's mobile device, the user's guardian's mobile device, and the PEP server when, for example, the interactive pet toy has been left outside, if the pet being played with is likely too hot or tired, if the temperature is too hot or cold, and if there has been a prolonged period of inactivity. The PEP app may also check current weather data from third party sources for temperature, ozone, particulate levels, pollen and other allergen levels, and storms and if hazardous conditions are or will soon be present at the user's location, automatically alert the user's mobile device and/or the guardian's mobile device, and/or send an alarm or other alert to the interactive pet toy whereby the interactive pet toy may display an alarm.

The interactive pet toy may have one or more outputs. In a preferred embodiment, and LED light(s) surface display can identify when daily goal has been reached, by, for example, all the lights will light up. In additional embodiments, lights flash to identify when charged/needs charge. A sound may automatically be emitted from the interactive pet toy via a speaker to alert the user when made daily goal or when is time to go out and initiate play with the pet. In further embodiments, vibration may be used for alerts too.

In further embodiments, the interactive pet toy has wireless technology to sync with the user's phone/mobile device and with the PEP server via the network.

The amount and type of user/pet activity can link with the userboard to rank users to award prizes.

The PEP app may send an alert to user's phone and guardian's phone/mobile device if something dangerous is/could happen with animal (overheating) or weather. In such conditions, the interactive pet toy could alternatively or additionally vibrate, make a loud noise, and/or light up—flashing light or different color/intensity—for example.

One embodiment of shape of the interactive pet toy ball is made to entice users, especially children users, and their pets to play and interact—including the fact that the interactive pet toy connects with the user's phone and allows the user to compete with friends and classmates over web and social media. The design of the ball has grooves to help the pet hold and catch the interactive pet toy ball. The design can also feature lights to indicate how much play time till their daily goal has been reached. The lights may also indicate how much battery life is left in the interactive pet toy ball. The design may feature decorative engraving, embossing, or printing.

One embodiment of the design of the interactive pet toy wand is intended to help motivate users, especially children users, to be active with their cats—including engaging with the users online and with the user's phone while the user is using the interactive pet toy wand. The interactive pet toy wand is made to be an attractive product for users to encourage them to play with their pets. The disclosed design of the handle aids in providing comfort when a hand is holding it and wrapped around it. The handle's curved features may also provide a layer of safety so that the user or pet are prevented from getting poked or stabbed by the comparatively thinner rod. The design may feature decorative engraving, embossing, or printing. The design may include lights to indicate how much play time till their daily goal has been reached. The lights may also indicate how much battery life is left in the interactive pet toy wand.

The interactive pet toy ball preferably gives when compressed from any direction, similar to a solid rubber ball or tennis ball, and does not have any glass. The interactive pet toy ball can be squeezed in the jaws of a large dog without breaking the interactive pet toy ball or harming the dog.

In one embodiment, the interactive pet toy will communicate with the PEP app on the user's mobile device. When it is time to play, based on predetermined set play time, for example, the mobile device may send a signal from the PEP app to the interactive pet toy to trigger a push notification via the interactive pet toy, PEP app, or both. The PEP app may also send an alert to the interactive pet toy and/or display an alert on the user's mobile device when it is time to play. Parents can also set alerts and reminders for user children to interact with their pets. The interactive pet toy may automatically make a sound or light up when it is time to play and the PEP app may sound and light up on the user and/or parent's mobile device.

The user and guardian mobile devices may include mobile internet devices, tablets, such as Samsung™ Galaxy Tab 4 10.1 and Apple™ iPad Pro 12.9 (2nd gen), smartphones, such as the Samsung™ Galaxy S9/S9+ and the Apple iPhone 8, 8 plus and X, laptops, wearable computers, such as smartwatches like the Apple™ Watch Series 3 model and the Samsung™ LTE Galaxy Watch, and head-mounted displays like Google™ Glass. The components of such devices are incorporated by reference.

The interactive pet toy may sync with user's mobile device and the PEP app to keep track of how much activity is spent with the interactive pet toy, and assumedly the pet, in motion. The interactive pet toy may track activity level and motion. The interactive pet toy may alert, sound, or light up when the recommended amount of exercise has been achieved, and send further and preferably distinct alerts if the amount of exercise has been moderately exceeded, and greatly exceeded. The PEP app may send an alert to the user's phone and possibly the parents' phone as well to alert them that their daily goal has been met.

A goal of one embodiment of the interactive pet toy and system is to incentivize and encourage play between kids and their pets and to build lasting and healthy bonds between kids and their pets in efforts to keep pets in homes and out of shelters. The interactive pet toy may get kids and their pets active, providing the extra benefit to the child and the pet of daily physical activity. One embodiment of the interactive pet toy is created with kids in mind to be a product that is suitable in size, weight, and physical attributes.

A goal of one embodiment of interactive pet toy and system is to build accountability and healthy pet care habits and responsibilities in children and teens. A further goal of one embodiment of the interactive pet toy and system is intended to alleviate the burden of pet care related tasks from parents to children.

The rewards system may create an incentive based feature to allow users to earn points to cash into rewards redeemable through the PEP app. The points may also rank users on a leaderboard and give users a score determined on their pet playing performance and use of the products and the PEP app.

A goal of a further embodiment is to educate young pet owners on the responsibilities of pet care and the tasks that come with raising a happy and healthy pet. One embodiment of this system assists in teaching lessons of accountability, responsibility, and empathy, and inspires and builds an emotional connection between the user and their pets in an effort to reduce the number of pets surrendered into shelters and euthanized. One embodiment of this system will also help improve the quality of life for pets and their family members. Pets that get proper exercise are less likely to misbehave and be destructive, which creates an optimal home environment. One embodiment of this system will promote use and daily exercise for the pet and the user. This will benefit the pet and user's physical and mental wellbeing.

The invention relates to an interactive pet toy comprising a shell, a processor, a memory, a wireless transmitter, one or more sensors, an output, and power source. Additional embodiments of the interactive pet toy further comprise an input. Additional embodiments of the interactive pet toy include where one or more sensors includes one of a sound sensor, a temperature sensor, a motion sensor, a GPS sensor, an accelerometer, an altitude sensor, a position sensor, a direction sensor, a moisture sensor, a light sensor, a color sensor, a tension sensor, a pressure sensor, an electromagnetic pulse sensor, an electromagnetic interference sensor, a magnetometer, and a gyroscope. Additional embodiments of the interactive pet toy include where one or more sensors includes between four and eight of a sound sensor, a temperature sensor, a motion sensor, a GPS sensor, an accelerometer, an altitude sensor, a position sensor, a direction sensor, a moisture sensor, a light sensor, a color sensor, a tension sensor, a pressure sensor, an electromagnetic pulse sensor, an electromagnetic interference sensor, a magnetometer, a timer, and a gyroscope. Additional embodiments of the interactive pet toy include wherein the output further comprises a surface display. Additional embodiments of the interactive pet toy include wherein the surface display includes one or more LED lights. Additional embodiments of the interactive pet toy include wherein the toy is substantially in the shape of a ball. Additional embodiments of the interactive pet toy include further comprising a shaft attaching to a first end of a rod and an attachment attached to a second end of the rod, where the processor is contained within the shaft. Additional embodiments of the interactive pet toy include further comprising the attachment being one of screwed and clipped onto the second end of the rod. Additional embodiments of the interactive pet toy include wherein the shell is a material with a Modulus of Elasticity of between 0.01 and 0.1 GPa, and the shell substantially completely fills an interior of the toy not occupied by internal components or wiring.

The disclosed invention further relates to an interactive pet toy system comprising an interactive pet toy including a shell, a processor, a non-volatile memory, a wireless transmitter, one or more sensors, an output; and a battery; and a mobile device, comprising a processor, a display screen, a non-volatile memory, and a wireless transmitter, wherein instructions are stored on the interactive pet toy memory and the and the mobile device memories that, when enacted by the respective processors, each track an interaction between a user and a pet. Additional embodiments of the system include further comprising instructions stored in the interactive pet toy memory to cause the interactive pet toy to wirelessly communicate with the mobile device data from the interaction between the user and the pet. Additional embodiments of the system include wherein one or more sensors includes between four and eight of a sound sensor, a temperature sensor, a motion sensor, a GPS sensor, an accelerometer, an altitude sensor, a position sensor, a direction sensor, a moisture sensor, a light sensor, a color sensor, a tension sensor, a pressure sensor, an electromagnetic pulse sensor, an electromagnetic interference sensor, a magnetometer, a timer, and a gyroscope. Additional embodiments of the system include further comprising instructions being stored on the interactive pet toy memory to cause data from each of the one or more sensors being wirelessly sent from the interactive pet toy to the mobile device. Additional embodiments of the system include further comprising a PEP server and a PEP database, each being remote in location from the interactive pet toy and the mobile device, the mobile device communicating data of the user and the pet with the PEP server via a network. Additional embodiments of the system include further comprising the PEP server comparing the user data with addition user data stored in the PEP database, ranking the user data, and communicating ranking and additional users data to the mobile device

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a symbolic cross-sectional view of a smooth surfaced ball shaped embodiment of the interactive pet toy according to the disclosed invention;

FIGS. 2A and 2B are respectfully top and side three dimensional views of a contoured surface ball embodiment of the interactive pet toy;

FIGS. 3-5 are views of a contoured surface cat wand embodiment of the interactive pet toy, with FIG. 3 showing a partial up-close top three dimensional view of the handle, FIG. 4 showing a partial up-close bottom three dimensional view of the handle, and FIG. 5 showing the a full three dimensional view of the cat wand;

FIG. 6 is an illustrated a block diagram of a computing system operable to execute the PEP app (or “PEP module”); and

FIG. 7 is a schematic diagram of the data communications of the various devices in one embodiment of the interactive pet toy system, utilizing the PEP app.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. The embodiments set forth the below represent the necessary information to enable those skilled in the art to practice the invention and illustrate the best mode of practicing the invention. In addition, the invention does not require that all the advantageous features and all the advantages need to be incorporated into every embodiment of the invention.

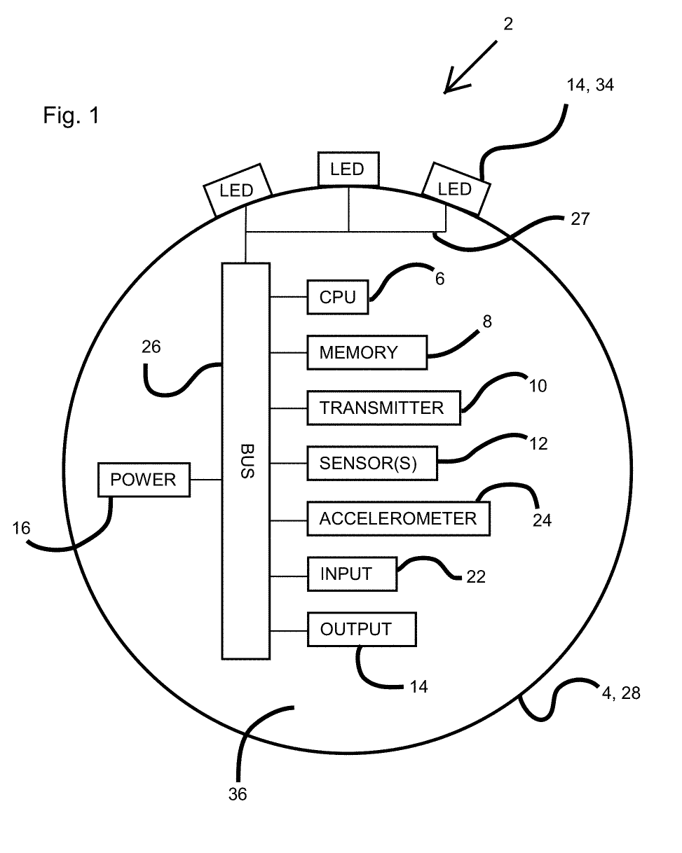

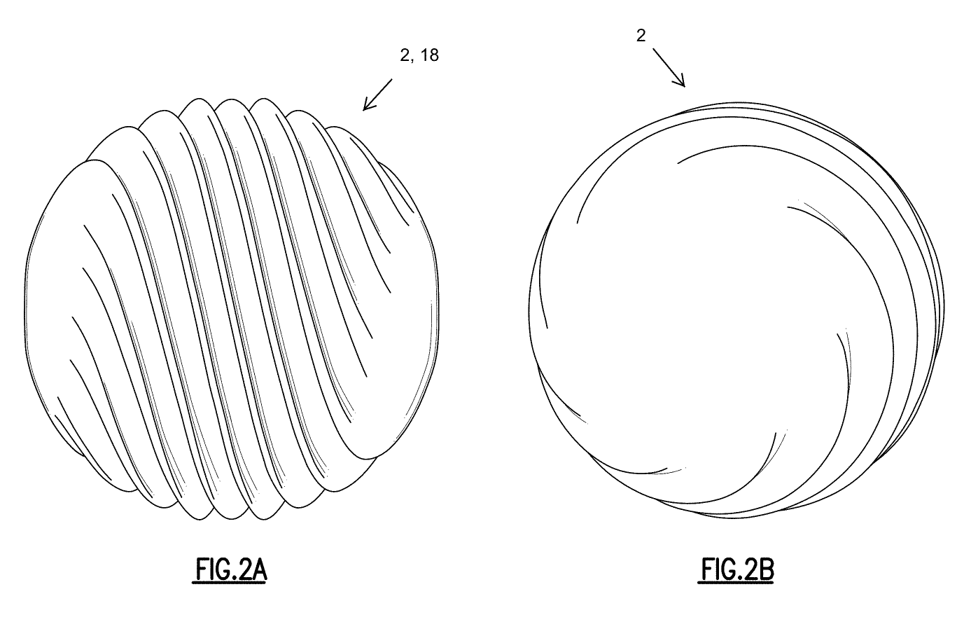

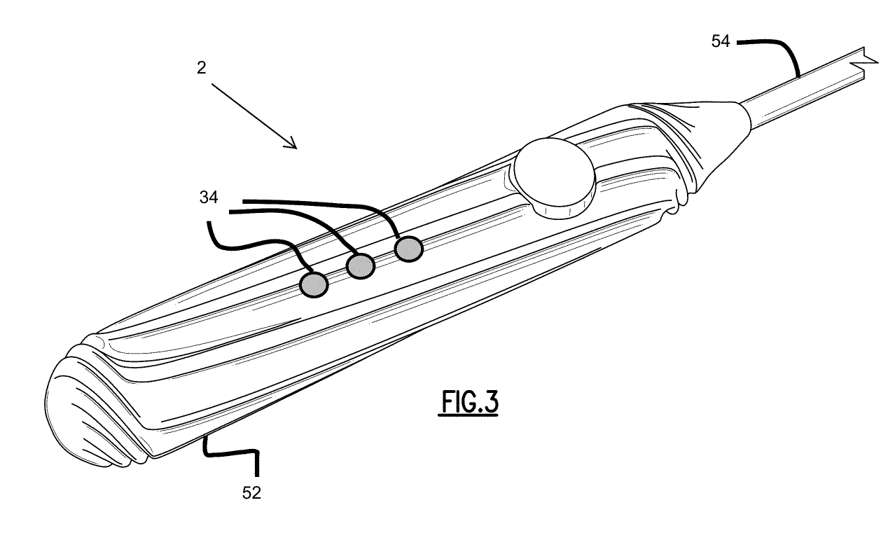

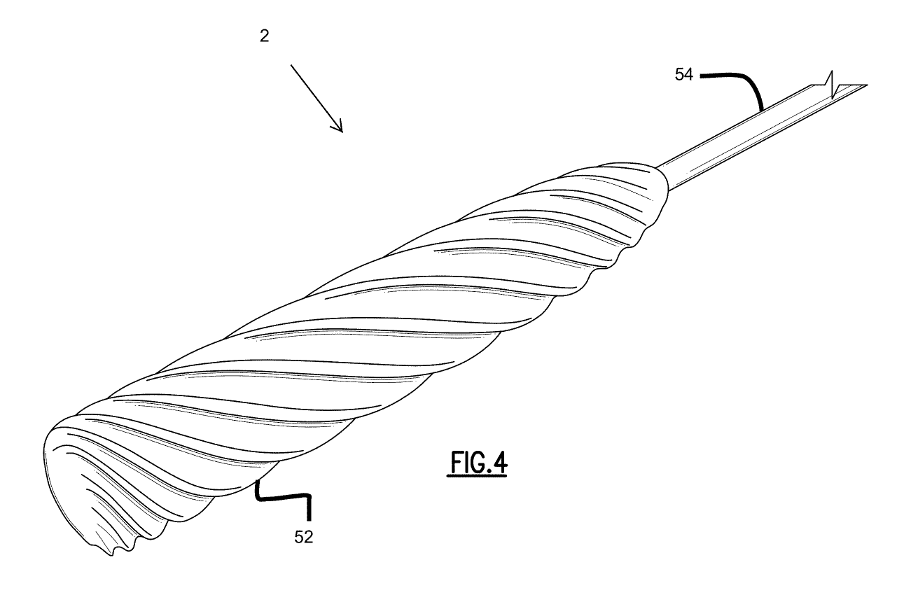

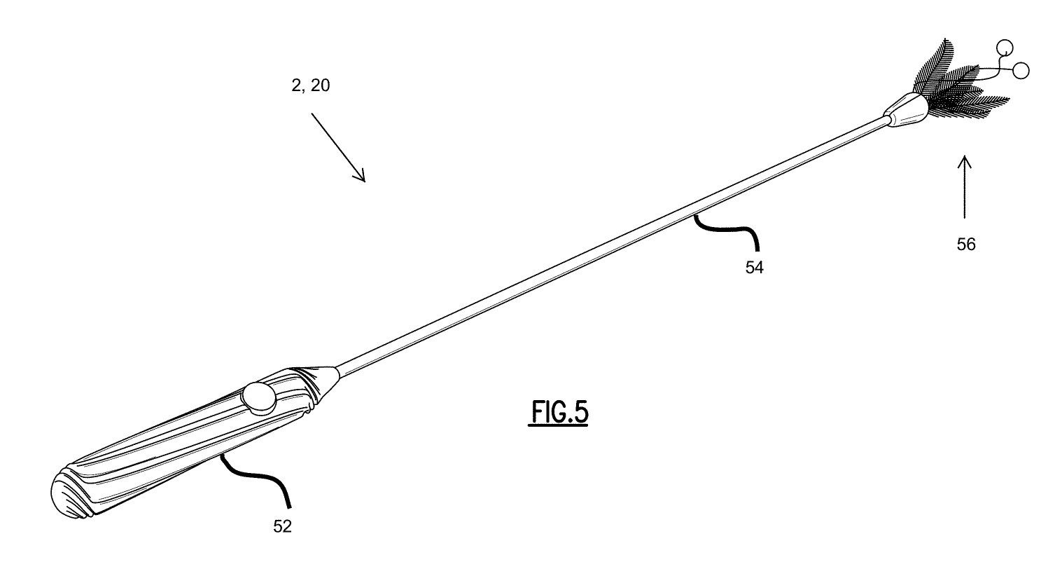

Turning now to FIG. 1, a brief description concerning the various components of the present invention will now be briefly discussed. The disclosed invention relates to methods and devices for an interactive pet toy 2. The interactive pet toy preferably comprises a shell 4, a processor 6, a memory 8, a wireless transmitter 10, a sensor 12, an output 14, and power source 16. Two of a number of embodiments for the interactive pet toy 2 include an interactive dog toy 18 (FIGS. 2A and 2B, for example) and an interactive cat toy 20 (FIGS. 3-5, for example). As shown in FIG. 1, the interactive pet toy 2 preferably includes an internal wireless transmitter 10, a microprocessor 6, memory 8, a power source 16 such as a battery or capacitor for example, one or more sensors 12, an input 22, an output 14, an accelerometer 24, and a BUS 26 or other electrical connections 27 between the internal components to allow proper communication and power between the internal components, including the power source 16.

The interactive dog toy 18 is preferably a round or substantially round rubber and/or other durable material ball with a diameter of preferably between 1.0 and 10.0 inches, more preferably between 2.0 and 5 inches, and most preferably between 2.5 and 3 inches. The interactive dog toy 18 may be a substantially solid ball, with a swirl ringed design, as shown in FIGS. 2A and 2B, that wraps around the ball for easy gripping by the user 30 and their pet 32. The exterior surface 28 may feature an embossed logo.

The exterior surface 28 may have a surface display 34 as the, or one of the, output(s). The surface display may be number of LED lights 34 (three shown in FIG. 1, though the number can be 1, 2, 4, 5, and higher also) that can flash and light up as the pet and user 30 engage in activity. The LED lights 34 may be flush with the exterior surface 28, protrude from the exterior surface 28, be recessed into the exterior surface 28, some combination of thereof, and/or may be entirely under the exterior surface 28.

The surface display 34 may contain lights 34 that may progressively light up as the pet 34 and user 30 progress to in accomplishing a daily activity goal, including the plurality of LED lights embodiment, an LED display embodiment, and an OLED display embodiment, just for example. This progress toward the daily goal can be indicated by, for example, an increase in the number of lights 34, and increase or change in the area of the exterior surface 28 lit, and/or an increase in the intensity of the light given off by the lights 34. Additionally or alternatively, the surface display 34 can be programmed to change colors for the amount of the activity exerted. An LED/OLED or similar feature 34 can envelop the exterior surface 28 or project colors from the interior 36 of the interactive pet toy 2 onto the exterior surface 28 and/or through a lens in the exterior surface 28 to output data, including to demonstrate the amount of activity that needs to be completed, the amount of activity that has been completed, and/or when the desired goal is achieved. The surface displays 34 are anticipated, though not required, in both the interactive dog toy 18 and cat toy 20 embodiments.

Sensors 12 in the interactive pet toy 2 may include one, two, three, four, five, six, seven, eight, nine, ten, or all off sound sensors 12, heat/cold/temperature sensors 12, motion sensors 12, GPS sensors 12, accelerometers 24, altitude sensors 12, position sensors 12, direction sensors 12, moisture sensors 12, light and color sensors 12, tension sensors 12, pressure sensors 12, electromagnetic pulse sensor 12, electromagnetic interference sensor 12, magnetometers 12 and gyroscopes 12, for example. The sensors 12 could detect that the user 30 is appropriately playing with or handling the interactive pet toy 2 and pet 32 in an appropriately safe environment. For example, sound detection with the sound sensor 12, processed in the processor 6 and/or sent via the wireless transmitter 10 to the user's mobile device 38 to process, could detect sounds of or associated with various conditions such as distress, joy, panting, yelping, laughter, barking, purring, hissing or tiredness on behalf of the user 30 and/or the pet 32. The sensors 12 may also detect the weather and temperatures outside and warn users via the PEP app if conditions are hazardous, such as temperatures being too hot (above 90, 95, or 100 degrees F. for example) or too cold (below 32, 20, or 10 degrees F. for example) and not suitable for outdoor play or if play should be conducted in shorter periods or in less strenuous methods (walk, not run when hot out, for example). Additionally, hazardous conditions where likely no play outside would be safe, such as lightning could be detected by electromagnetic pulse and/or electromagnetic interference sensors 12. Lightning could be indirectly detected by detecting the sound of thunder. The interactive pet toy 2 could then send an alert to the user's phone via the PEP app 40. Additionally, the PEP app 40 could monitor weather forecasts for the location of the user for hazardous weather conditions including temperature extremes, lightning, storms, wind, rain, snow, ice. If conditions are dangerous for outside play or there are indications of injury or excessive play the interactive pet toy 2 could turn off, send a warning output, and/or send a warning message to the user's mobile device. If the user continues to play with the interactive pet toy 2 despite the warnings, an additional alert may then be sent to the mobile device 38 of the user's guardian 42, such as a parent or teacher, notifying the guardian 42 that the pet 32 and quite possibly the user 30 are in danger. Other sensors 12 and cameras can be included in the interactive pet toy 2 to physically monitor the motions, activity, and environment of both the pet 32 and user 30. An output 14 in the form of a speaker 42 in and/or on the interactive pet toy 2 can interact with the user 30 by emitting sounds, alerts, and words of affirmation for a job well done or warnings of rough play or dangerous playing habits, as the situation requires.

The terms “PEP app” 40 and “the app” 40 are understood to be interchangeable with the “PEP module” 40.

The interactive pet toy 2 is intended for owners 30 to play with their pets 32 and may track how long both the owner 30 and the pet 32 are active. The data may then be sent via the wireless transmitter 10 from the interactive pet toy 2 directly or indirectly to the user's mobile device 38, for example, running the PEP app 40, for example. The wireless transmitter 10 may transmit and receive data wirelessly 44 via Wi-Fi (or Wireless Fidelity), WiMax, cellular, and Bluetooth™ wireless technologies, for example to and from the user's mobile device 38. Thus, the communication can be a predefined structure as with a conventional network or simply an ad hoc communication between at least two devices 2, 38, including between some combination of 2, 3, of 4 of the user's mobile device 38, a first interactive pet toy 2, a second interactive pet toy 2, and the guardian's mobile device 38. Wi-Fi networks use radio technologies called IEEE 802.11x (a, b, g, etc.) to provide secure, reliable, fast wireless connectivity. A Wi-Fi network can be used to connect multiple interactive pet toys 2 to each other, to the user's mobile device 38, to the guardian's mobile device 38, through a network 46 to the Internet, and to wire networks (which use IEEE 802.3-related media and functions). The data will then preferably be sent to the PEP server 48 and PEP database 50, where the PEP server 48 may rank the user 30 against the user's peers and other users of the PEP app 40, and the ranking data may be sent back to the user's mobile device 38 and displayed via the PEP app 40 on the user's mobile device 38.

Timers and challenges can be set via the PEP app 40 so users 30 may fulfill their role in being active with their pets 32 as defined, for example, in a set amount of time of activity in a given day, and/or a certain type of activity in a given day. The time of activity can be varied by the level of vigorousness of the activity. For example, running with the user's dog 32 may count as more activity for a given amount of time than walking with the dog 32, and rolling the interactive pet toy 2 ball slowly where the dog 32 walks to the interactive pet toy 2 ball to retrieve it may count as less activity for a given amount of time than throwing the interactive pet toy 2 ball a longer distance, causing the dog 32 to run after the interactive pet toy 2 ball to retrieve it. When the user 30 and pet 32 fulfill their hourly, semi-daily, or daily goals, for example, the LED lights 34 may automatically blink and the interactive pet toy 2 may send a push notification to the user's phone 38 and/or the user's parent's phone 38, notifying each that the user's daily task is complete. Other options for notifications, in addition to or alternative to the LED lights 34 or other surface display 34, include, for example, a vibration or sound that emits from the interactive pet toy 2 and mobile device 38 via the PEP app 40. Sounds can be verbal or alerts sounds in various tones.

The interactive pet toy 2 may preferably feature necessary internal components so that the interactive pet toy 2 is a ULP (ultra-low power) or ULV (ultra-low voltage) system, including a preferably very low power drawing sensor 12, memory 8, transmitter 10 and microchip or microprocessor 6, for example, and a power source 16 such as one or more batteries that may be encased inside a pet safe material. Bluetooth Low Energy-equipped wireless power transmitter and RF energy harvesting chips, such as Nordic Semi™ transmitters, and similarly functioning hardware 10 may be included.

The interactive pet toy 2, and especially the interactive pet toy 2 dog toy 18 embodiments, will preferably be waterproof and more preferably not have any modules that open or retract. This design may not need a charger or charging device, especially if the interactive pet toy 2 uses an ultra-low power system and components. Alternative embodiments can use power sources 16 such as watch batteries, rechargeable batteries, and including charging by motion, or wireless charging.

Motion detection sensors 12 can be used to sense if there is a rapid deceleration in speed of the interactive pet toy 2 followed by a yelp or sound of pain, for instance, such as might happen if the interactive pet toy 2 ball was thrown and it hit the pet 32. This would preferably be interpreted by the CPU or processor 6 as a negative interaction, stored in the memory 8, and data wirelessly transmitted 44 and reported to the guardian's mobile device 38. If a predetermined limit number or degree of negative interactions are exceeded, the interactive pet toy 2 may suspend the PEP app ranking tracking until unlocked by either a PEP administrator and/or the guardian, for example.

Further embodiments of the interactive pet toy 2 may include one or more motors and/or mobility features such that, for example, if the interactive pet toy 2 ball is left outside or hidden somewhere in the user's house, the user may press a button on the PEP app 40 to have the interactive pet toy 2 ball roll to the user 30 or into a toy box. Additionally or alternatively, the user's mobile device 38 can wirelessly communicate with the interactive pet toy 2 to discover where the interactive pet toy 2 is, such as from a GPS sensor 12 in the interactive pet toy 2, an/or through triangulation from wireless transmissions 44 sent and received between the two devices 2, 38, especially when the user moves the mobile device 38 with respect to the interactive pet toy 2.

The interactive pet toy 2 may be in a number of shapes, including tug toys, bone shaped, randomly shaped pet toys, non-specific shapes, cat wands (FIGS. 3-5, for e.g.), cat lasers, and reduced sized toys for cats (in variety of shapes, such as balls and mice, etc.).

In one embodiment, the interactive pet toy 2 preferably has an exterior surface 28 encasing an interior 36 having a battery 16, a sensor or sensors 12, a CPU/microprocessor 6, memory 8, and a wireless transmitter 10. A plurality of LED lights 34 preferably blink when daily goals are met, or an LED panel 34 or an OLED display 34 that displays or emits different colors, badges, or alerts, including when daily goals are met, or that acts as input 22 and/or output 14 for different messages, to input data, request functions, or to add functionality to the interactive pet toy 2—such as a light to light up the interactive pet toy 2 to allow for play after dark.

The PEP App 40 preferably synchs with and registers user 30 data from the interactive pet toy 2 up to the PEP server 48 and the user 30 data are uploaded to leaderboards, which are transmitted from the PEP server to the PEP app 40 on the user's mobile device 38.

In another embodiment of the interactive pet toy 2, durable surface material/shell 4 and durable encasing material is used that is able to withstand play with dogs of all sizes while retaining functionality of internal components 6, 8, 10, 12, 14, 16 and preferably preventing leakage, cracking, or loosening of internal components and associated ingestion by pet. The durable surface material/shell 4 will protect the inside encasing from ever being exposed. The encasing may substantially fill the interior 36 of the interactive pet toy 2 that is not filled by internal components or wires.

In a similar embodiment, the interior 36 of the interactive pet toy 2 may include internal components, such as a battery 16, a sensor 12, a CPU 6, and a wireless transmitter 10. The interior components are preferably molded into a core material that will aid in durability of the interactive pet toy 2, enclosed in the surface exterior 28 and secured at the core interior 36 of the interactive pet toy 2 ball.

In another embodiment, the surface display 34, such as three LED lights 34, can indicate the amount of activity between the pet 32 and user 30. The user 30 may set the daily challenges through the PEP app 40 and the LED lights 34 can indicate how close the user 30 and the pet 32 are to their daily goals. The LED lights 34 can blink and the PEP app 40 may send a push notification 44 to the user's phone or mobile device 3 to notify the user 30 that the daily goal has been met.

The PEP app 40, also referred a smartphone app or tablet app, will preferably feature an interactive pet toy 2 component that syncs with the interactive pet toy 2 to track how long the pet 32 and user 30 have been active, including the level of vigorousness of the activity, and preferably any positive or negative indicia from the interactions. The PEP server 48 will preferably receive data 44 from the interactive pet toy 2 and or the user's mobile device 38, compile the data with data from other users, and will preferably list the data on a leaderboard with other users on the user's mobile device 38. The users 30 will preferably receive prizes, such as gaining virtual or digital badges and a spot on the leaderboard based on the amount and quality of activity played with their pets 32 as motivational aids to perpetuate positive pet care behaviors.

The power source 16 options can include direct power and or stored power. Stored power options include capacitors and a variety of battery options with associated components. Charging and direct power can also come from kinematic wireless charging through the motions of playing with the ball, wireless charging/wireless charging docks (including, for example inductive charging and resonance charging), and integrated photovoltaic charging. For the wand cat toy 20 embodiment of the interactive pet toy 2 and other embodiments with exterior surfaces 28 not intended to be chewed on, a plug in data and/or power port may be provided in an area where the pet will not interact with the interactive pet toy 2, such as the handle 52.

Turning next to FIGS. 3-5, a cat toy embodiment 20 of the interactive pet toy 2 is shown. In this embodiment, the interactive pet toy 2 includes a want handle 52, wand rod 54, and attachment 56. The attachment 56 is preferably interchangeable.

The interactive pet toy 2 is preferably targeted and equipped for children. The messages and tips that the PEP app will receive and display on the mobile device 38 will be preferably age appropriate. According to one embodiment, the user's age is preferably under 18, under 14, under 12, or under 10 for example, and over 3, over 5, or over 6 for example.

The interactive pet toy 2, especially the embodiments where substantially all of the interactive pet toy 2 is designed to be within a pet's 32 mouth during play, preferably does not have any modules or removable pieces that can be swallowed by children users 30 or pets 32.

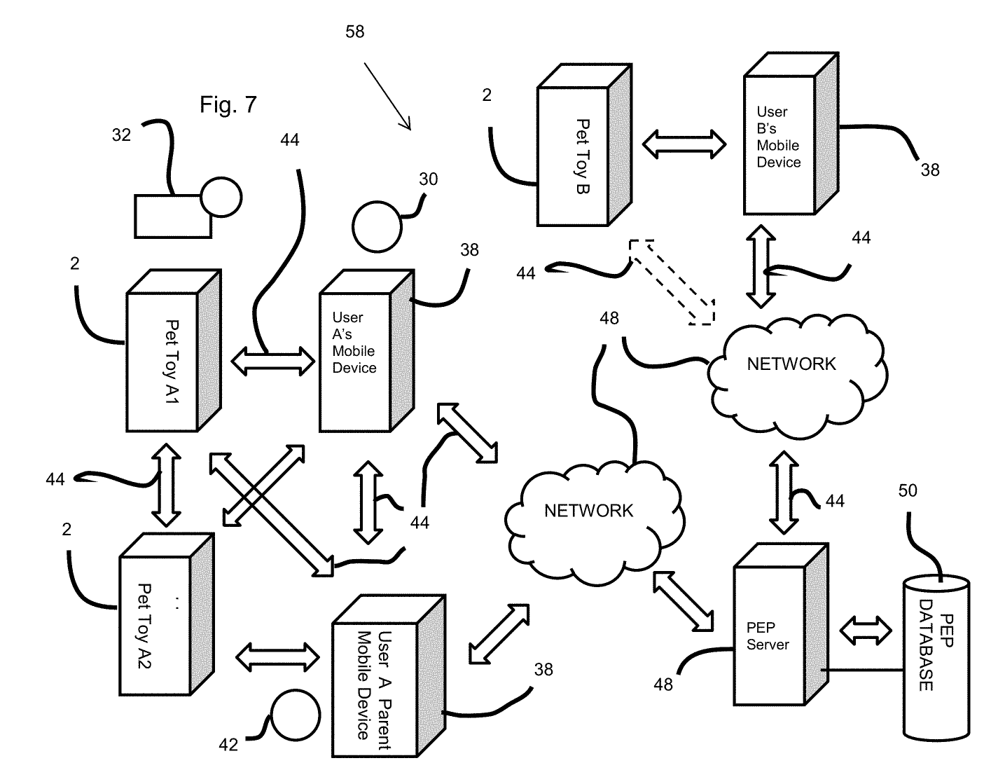

As shown in FIG. 7, the interactive pet toy(s) 2, together with the mobile device 38, the PEP app 40, and the PEP server and PEP database are part of the disclosed interactive pet toy system 58, which, in different embodiments, combines play, responsibility, motivation, supervision, competition, and toys with activity for the user 30 and the pet 32.

As used in this application, the terms “component” and “system” may refer to a computer-related entity, either hardware, a combination of hardware and software, software, or software in execution. For example, a component can be, but is not limited to being, a process running on a processor 6, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

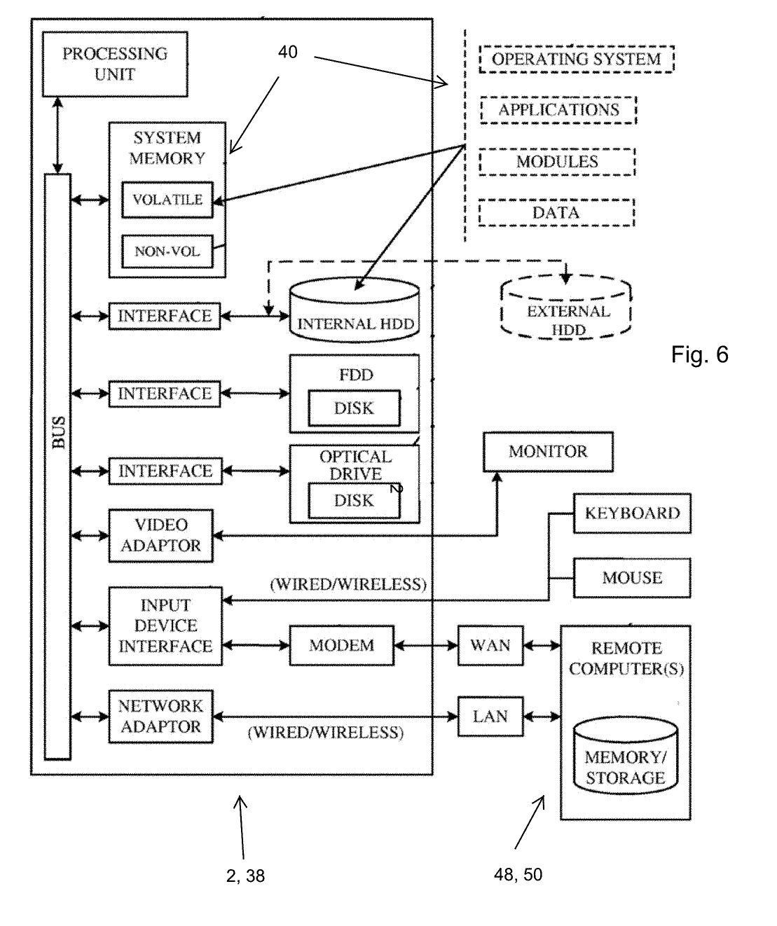

Referring now to FIG. 6 there is illustrated a block diagram of a computing system operable to execute the PEP module in accordance with the disclosed architecture. In order to provide additional context for various aspects thereof, FIG. 6 and the following discussion are intended to provide a brief, general description of a suitable computing system in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, such as video/photo enabled “smart phones”, microprocessor-based or programmable consumer electronics, and the like, each of which can be operatively coupled to one or more associated devices.

In this description, the term “module” refers to computational logic for providing the specified functionality. A module can be implemented in hardware, firmware, and/or software. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices, loaded into memory, and executed by the one or more processors. It will also be appreciated that the operations of the PEP module service require computer implemented elements (e.g., memory, processor, etc.) and cannot be performed by the human mind as mere mental steps.

The illustrated aspects can also be practiced in distributed computing environments where certain tasks are performed by remote processing devices that are linked through a communications network. In a distributed computing environment, program modules can be located in both local and remote memory storage devices.

The computer will typically include a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 6, the exemplary computing system for implementing various aspects of the method and system includes a computer having a processing unit, a system memory and a system bus. This computer can be representative of the interactive pet toy, the user's mobile device, the user's parent's device, and/or the PEP server. The system bus provides an interface for system components including, but not limited to, the system memory to the processing unit. The processing unit can be any of various commercially available processors. Dual microprocessors and other multi-processor architectures may also be employed as the processing unit.

The system bus can be any of several types of bus structure that may further interconnect to a memory bus (with or without a memory controller), a peripheral bus, and a local bus using any of a variety of commercially available bus architectures. The system memory can include non-volatile memory (NON-VOL) and/or volatile memory (e.g., random access memory (RAM)). A basic input/output system (BIOS) can be stored in the non-volatile memory (e.g., ROM, EPROM, EEPROM, etc.), which BIOS are the basic routines that help to transfer information between elements within the computer, such as during start-up. The volatile memory can also include a high-speed RAM such as static RAM for caching data.

The computer further preferably includes an internal hard disk drive (HDD) (e.g., EIDE, SATA), which internal HDD may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as a DVD). The HDD, FDD and optical disk drive can be connected to the system bus by a HDD interface, an FDD interface and an optical drive interface, respectively. The HDD interface for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory, including an operating system, one or more application programs, other program modules, and program data. The one or more application programs, other program modules, and program data can include the PEP system.

All or portions of the operating system, applications, modules, and/or data can also be cached in the volatile memory.

A user can enter commands and information into the computer through one or more wire/wireless input devices, for example, a keyboard and a pointing device, such as a mouse. Other input devices (not shown) may include a microphone, an IR remote control, a joystick, a game pad, a stylus pen, touch screen, or the like. These and other input devices are often connected to the processing unit through an input device interface that is coupled to the system bus, but can be connected by other interfaces such as a parallel port, IEEE 1394 serial port, a game port, a USB port, an IR interface, etc. A monitor or other type of display device is also connected to the system bus via an interface, such as a video adaptor. In addition to the monitor, a computer typically includes other peripheral output devices (not shown), such as speakers, printers, etc.

The computer may operate in a networked environment using logical connections via wire and/or wireless communications to one or more remote computers, such as a remote computer(s). The remote computer(s) can be a workstation, a server computer, a router, a personal computer, portable computer, microprocessor-based entertainment appliance, a peer device or other common network node, and typically includes many or all of the elements described relative to the computer, although, for purposes of brevity, only a memory/storage device is illustrated. The logical connections depicted include wire/wireless connectivity to a local area network (LAN) and/or larger networks, for example, a wide area network (WAN). Such LAN and WAN networking environments are commonplace in offices and companies, and facilitate enterprise-wide computer networks, such as intranets, all of which may connect to a global communications network, for example, the Internet.

When used in a LAN networking environment, the computer is connected to the LAN through a wire and/or wireless communication network interface or adaptor. The adaptor can facilitate wire and/or wireless communications to the LAN, which may also include a wireless access point disposed thereon for communicating with the wireless functionality of the adaptor.

When used in a WAN networking environment, the computer can include a modem, or is connected to a communications server on the WAN, or has other means for establishing communications over the WAN, such as by way of the Internet. The modem, which can be internal or external and a wire and/or wireless device, is connected to the system bus via the input device interface. In a networked environment, program modules depicted relative to the computer, or portions thereof, can be stored in the remote memory/storage device. It will be appreciated that the network connections shown are exemplary and other means of establishing a communications link between the computers can be used.

The computer is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The invention illustratively disclosed herein suitably may explicitly be practiced in the absence of any element which is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items while only the terms “consisting of” and “consisting only of” are to be construed in the limitative sense.

Wherefore, I claim:

1. An interactive pet toy comprising:
a shell;
a processor;
a memory;
a wireless transmitter;
one or more sensors;
an output; and
a power source.

2. The interactive pet toy of claim 1 further comprising an input.

3. The interactive pet toy of claim 1 wherein one or more sensors includes one of a sound sensor, a temperature sensor, a motion sensor, a GPS sensor, an accelerometer, an altitude sensor, a position sensor, a direction sensor, a moisture sensor, a light sensor, a color sensor, a tension sensor, a pressure sensor, an electromagnetic pulse sensor, an electromagnetic interference sensor, a magnetometer, and a gyroscope.

4. The interactive pet toy of claim 1 wherein one or more sensors includes between four and eight of a sound sensor, a temperature sensor, a motion sensor, a GPS sensor, an accelerometer, an altitude sensor, a position sensor, a direction sensor, a moisture sensor, a light sensor, a color sensor, a tension sensor, a pressure sensor, an electromagnetic pulse sensor, an electromagnetic interference sensor, a magnetometer, a timer, and a gyroscope.

5. The interactive pet toy of claim 1 wherein the output further comprises a surface display.

6. The interactive pet toy of claim 5 wherein the surface display includes one or more LED lights.

7. The interactive pet toy of claim 1 wherein the toy is substantially in the shape of a ball.

8. The interactive pet toy of claim 1 further comprising a shaft attaching to a first end of a rod and an attachment attached to a second end of the rod, where the processor is contained within the shaft.

9. The interactive pet toy of claim 8 further comprising the attachment being one of screwed and clipped onto the second end of the rod.

10. The interactive pet toy of claim 1 wherein the shell is a material with a Modulus of Elasticity of between 0.01 and 0.1 GPa, and the shell substantially completely fills an interior of the toy not occupied by internal components or wiring.

11. The interactive pet toy of claim 1 wherein the power source is one a battery and a capacitor.

12. An interactive pet toy system comprising:
an interactive pet toy including a shell, a processor, a non-volatile memory, a wireless transmitter, one or more sensors, an output; and a power source; and
a mobile device; comprising a processor, a display screen, a non-volatile memory, and a wireless transmitter;
wherein instructions are stored on the interactive pet toy memory and the and the mobile device memories that, when enacted by the respective processors, each track an interaction between a user and a pet.

13. The system of claim 12 further comprising instructions stored in the interactive pet toy memory to cause the interactive pet toy to wirelessly communicate with the mobile device data from the interaction between the user and the pet.

14. The system of claim 12 wherein one or more sensors includes between four and eight of a sound sensor, a temperature sensor, a motion sensor, a GPS sensor, an accelerometer, an altitude sensor, a position sensor, a direction sensor, a moisture sensor, a light sensor, a color sensor, a tension sensor, a pressure sensor, an electromagnetic pulse sensor, an electromagnetic interference sensor, a magnetometer, a timer, and a gyroscope.

15. The system of claim 14 further comprising instructions being stored on the interactive pet toy memory to cause data from each of the one or more sensors being wirelessly sent from the interactive pet toy to the mobile device.

16. The system of claim 15 further comprising a PEP server and a PEP database, each being remote in location from the interactive pet toy and the mobile device, the mobile device communicating data of the user and the pet with the PEP server via a network.

17. The system of claim 16 further comprising the PEP server comparing the user data with addition user data stored in the PEP database, ranking the user data, and communicating ranking and additional users data to the mobile device.
